(19) United States
(12) Patent Application Publication
(10) Pub. No.: US 2025/0209750 A1
(43) Pub. Date: Jun. 26, 2025

(54) SYSTEMS AND METHODS FOR MANAGING DIGITAL NOTES FOR COLLABORATION

(71) Applicant: 3M INNOVATIVE PROPERTIES COMPANY, St. Paul, MN (US)

(72) Inventors: Philip E. Hague, St. Paul, MN (US); Yin Chen Quintero, San Gabriel, CA (US); Willem V. Bastiaens, Scandia, MN (US); Scott D. Lehman, Marietta, GA (US); Edward I. Stamm, JR., Roswell, GA (US); Nicklas A. Ansman Giertz, New York, NY (US); Pontus Axelsson, Stockholm (SE); Anders F. Järleberg, New York, NY (US); Carlo Rapisarda, Johanneshov (SE)

(21) Appl. No.: 18/845,592

(22) PCT Filed: Mar. 20, 2023
(86) PCT No.: PCT/IB2023/052725

§ 371 Date: Sep. 10, 2024

Related U.S. Application Data
(60) Provisional application No. 63/327,950, filed on Apr. 6, 2022.

(51) Int. Cl. G06T 19/00; G06F 3/01

(52) U.S. Cl. CPC G06T 19/006; G06F 3/017

(57) ABSTRACT

Methods for projecting, detecting, and processing digital notes. The digital notes can be displayed on a mixed reality device combined with physical notes in the same space. Physical notes can be automatically detected in view of a camera and converted to a corresponding digital note, and if the note has an obstruction the obstruction is removed in the digital note. Digital notes can be projected onto a wall and, upon detecting a change in scene, a new scene is projected onto the wall with the detected change. Physical notes can be automatically detected in view of a camera and converted to a corresponding digital note along with a recorded audio associated with the digital note.

### BACKGROUND

Paper notes have been broadly used in recording, sharing, and communicating ideas and information. For example, during a collaboration session (e.g., brainstorming session), participants write down ideas on repositionable paper notes, whiteboard, or paper, and then share with one another. In addition, people commonly use notes throughout the day to memorialize information or content which the individual does not want to forget. As additional examples, people frequently use notes as reminders of actions or events to take in the future, such as to make a telephone call, revise a document or to fill out a time sheet.

Software programs currently exist which permit computer users to create a software-based note in a digital form and to utilize the digital note within a computing environment. For example, a computer user may create a digital note and “attach” the digital note to an electronic document a desktop or electronic workspace presented by the computing environment.

### SUMMARY

A method for synchronizing digital and physical notes displays digital notes onto a wall or surface and captures physical notes, via an image capture device, which converts them into corresponding digital notes. For in-person users, digital notes are displayed alongside physical notes via projection, a mixed reality device, or mobile device. For digital users, all notes are also displayed on a synchronous electronic board.

A method for generating a digital note includes automatically detecting a physical note via an image capture device. The detected physical note is converted to a corresponding digital note. If the note has an obstruction, the obstruction is removed in the digital note.

A method for displaying digital notes includes projecting digital notes onto a wall or surface for users and detecting a change in a scene, via an image capture device, on the wall or surface. The scene is updated based upon the detected change. A new scene is projected on the wall or surface based upon the update, and the new scene is shared on a common electronic board for the users.

A method for generating a digital note with audio includes automatically detecting a physical note, via an image capture device, on a wall or surface and converting the detected physical note to a corresponding digital note. Audio associated with the digital note is recorded and tagged to the digital note, and the digital note is displayed on an electronic board with the tag for the associated audio.

### BRIEF DESCRIPTION OF DRAWINGS

FIG. 1A is a representation illustrating one example of a user capturing an image of a workspace with notes using an image capture device on a mobile device.

FIG. 1B is a block diagram illustrating one example of the mobile device.

FIG. 1C is a block diagram illustrating one example of a note management application executing on the mobile device.

FIG. 1D illustrates another embodiment of a note recognition system.

FIG. 1E illustrates another embodiment of a note management system.

FIG. 2A is a diagram of a system for merging physical and digital notes into a single work canvas.

FIG. 2B is a flow chart of a method for merging physical and digital notes into a single work canvas.

FIG. 3A is a diagram of a system for note recognition with physical obstructions.

FIG. 3B is a flow chart of a method for note recognition with physical obstructions.

FIG. 4A is a diagram of a system for reducing data consumption by capturing only altered content of notes.

FIG. 4B is a flow chart of a method for reducing data consumption by capturing only altered content of notes.

FIG. 5A is a diagram of a system for synchronizing capture of notes with real-time audio and visual presentation.

FIG. 5B is a flow chart of a method for synchronizing capture of notes with real-time audio and visual presentation.

### DETAILED DESCRIPTION

### Overview

The present disclosure describes techniques for creating and manipulating software notes representative of physical notes. For example, techniques are described for recognizing physical notes present within a physical environment, capturing information therefrom and creating corresponding digital representations of the physical notes, referred to herein as digital notes or software-based notes. Further, at least some aspects of the present disclosure are directed to techniques for managing multiple notes.

In general, notes can include physical notes and digital notes. Physical notes generally refer to objects with a general boundary and recognizable content. Physical notes can include the resulting objects after people write, draw, or enter via other type of inputs on the objects, for example, paper, white board, or other objects accepting the inputs. By way of examples, physical notes can include hand-written repositionable paper notes, paper, or film, white-board with drawings, posters, and signs. In some cases, physical notes can be generated using digital means, e.g., printing onto printable repositionable paper notes or printed document. In some cases, one object can include several notes. For example, several ideas can be written on a piece of poster paper or a white-board. Physical notes can be two-dimensional or three dimensional. Physical notes can have various shapes and sizes. For example, a physical note may be a 3 inches×3 inches note; a physical note may be a 26 inches×39 inches poster; and a physical note may be a triangular metal sign. In some cases, physical notes have known shapes and/or sizes. Digital notes generally refer to digital objects with information and/or ideas. Digital notes can be generated using digital inputs. Digital inputs can include, for example, keyboards, touch screens, digital cameras, digital recording devices, stylus, digital pens, or the like. In some cases, digital notes may be representative of physical notes.

### Note Management System

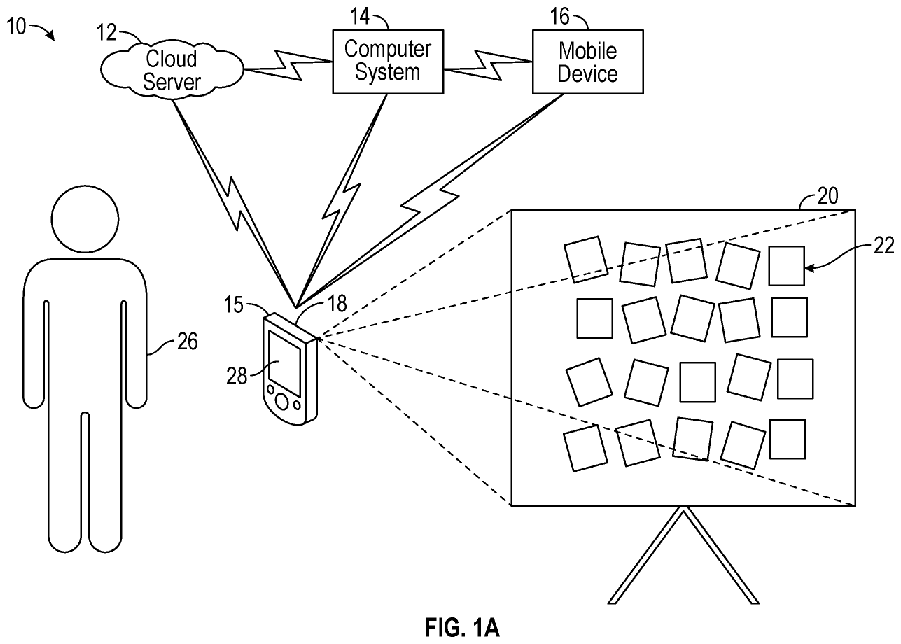

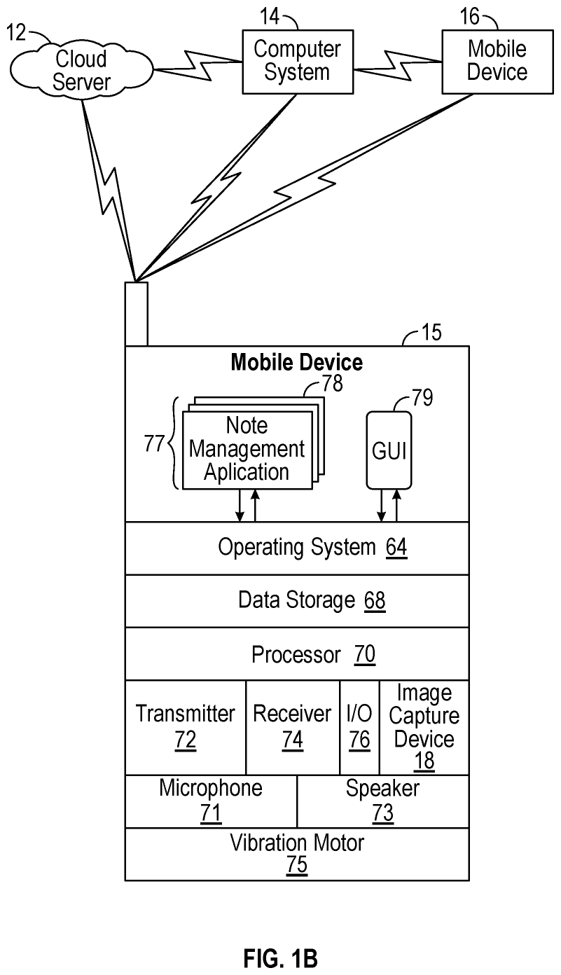

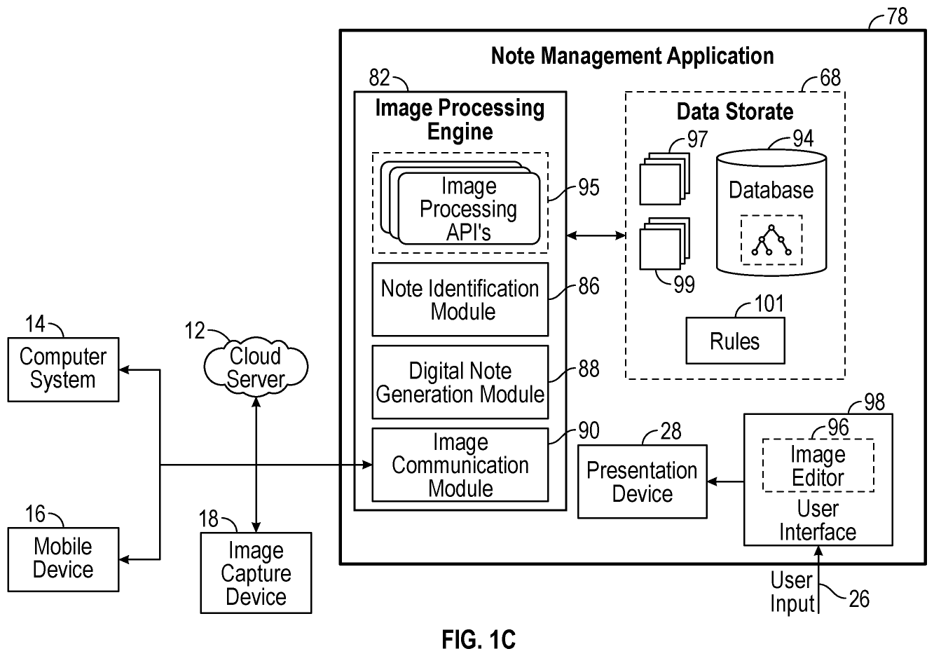

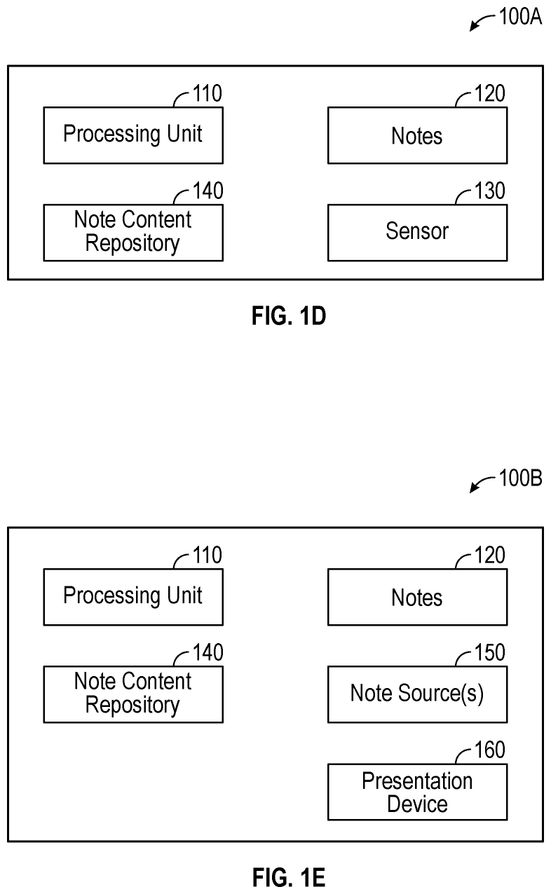

FIG. 1A illustrates an example of a note recognition environment 10. In the example of FIG. 1A, environment 10 includes a mobile device 15 to capture and recognize one of more notes 22 from a workspace 20. As described herein, mobile device provides an execution environment for one or more software applications that, as described, can efficiently capture and extract note content from a large number of physical notes, such as the collection of notes 22 from workspace 20. In this example, notes 22 may be the results of a collaborative brainstorming session having multiple participants. As described, mobile device 15 and the software executing thereon may perform a variety of note-related operations, including automated creation of digital notes representative of physical notes 22 of workspace 20.

In the example implementation, mobile device 15 includes, among other components, an image capture device 18 and a presentation device 28. In addition, although not shown in FIG. 1A, mobile device 15 may include one or more processors, microprocessors, internal memory and/or data storage and other electronic circuitry for executing software or firmware to provide the functionality described herein.

In general, image capture device 18 is a camera or other component configured to capture image data representative of workspace 20 and notes 22 positioned therein. In other words, the image data captures a visual representation of an environment, such as workspace 20, having a plurality of visual notes. Although discussed as a camera of mobile device 15, image capture device 18 may comprise other components capable of capturing image data, such as a video recorder, an infrared camera, a CCD (Charge Coupled Device) array, a laser scanner, Light Detection and Ranging technology (LiDAR), or the like. Moreover, the captured image data can include at least one of an image, a video, a sequence of images (i.e., multiple images taken within a time period and/or with an order), a collection of images, information from other sensors and potentially including depth data, or the like, and the term input image is used herein to refer to the various example types of image data.

Presentation device 28 may include, but not limited to, an electronically addressable display, such as a liquid crystal display (LCD) or other type of display device for use with mobile device 28. In some implementations, mobile device 15 generates the content to display on presentation device 28 for the notes in a variety of formats, for example, a list, grouped in rows and/or column, a flow diagram, or the like. Mobile device 15 may, in some cases, communicate display information for presentation by other devices, such as a tablet computer, a projector, an electronic billboard or other external device.

As described herein, mobile device 15, and the software executing thereon, provide a platform for creating and manipulating digital notes representative of physical notes 22. For example, in general, mobile device 15 is configured to process image data produced by image capture device 18 to detect and recognize at least one of physical notes 22 positioned within workspace 20. In some examples, the mobile device 15 is configured to recognize note(s) by determining the general boundary of the note(s). After a note is recognized, mobile device 15 extracts the content of at least one of the one or more notes, where the content is the visual information of note 22.

In some example implementations, mobile device 15 provides functionality by which user 26 is able to export the digital notes to other systems, such as cloud-based repositories (e.g., cloud server 12) or other computing devices (e.g., computer system 14 or mobile device 16).

In the example of FIG. 1A, mobile device 15 is illustrated as a mobile phone. However, in other examples, mobile device 15 may be a tablet computer, a personal digital assistant (PDA), a laptop computer, a media player, an e-book reader, a wearable computing device (e.g., a watch, eyewear, a glove), or any other type of mobile or non-mobile computing device suitable for performing the techniques described herein.

FIG. 1B illustrates a block diagram illustrating an example of a mobile device that operates in accordance with the techniques described herein. For purposes of example, the mobile device of FIG. 1B will be described with respect to mobile device 15 of FIG. 1A

In this example, mobile device 15 includes various hardware components that provide core functionality for operation of the device. For example, mobile device 15 includes one or more programmable processors 70 configured to operate according to executable instructions (i.e., program code), typically stored in a computer-readable medium or data storage 68 such as static, random-access memory (SRAM) device or Flash memory device. I/O 76 may include one or more devices, such as a keyboard, camera button, power button, volume button, home button, back button, menu button, or presentation device 28 as described in FIG. 1A. Transmitter 72 and receiver 74 provide wireless communication with other devices, such as cloud server 12, computer system 14, or other mobile device 16 as described in FIG. 1A, via a wireless communication interface as described in FIG. 1A, such as but not limited to high-frequency radio frequency (RF) signals. A microphone 71 converts audio information into corresponding electrical signals. A speaker 73 converts electrical signals into corresponding audio information. A vibration motor 75 is used to cause mobile device 15, or housing for it, to vibrate. Mobile device 15 may include additional discrete digital logic or analog circuitry not shown in FIG. 1B.

In general, operating system 64 executes on processor 70 and provides an operating environment for one or more user applications 77 (commonly referred to “apps”), including note management application 78. User applications 77 may, for example, comprise executable program code stored in computer-readable storage device (e.g., data storage 68) for execution by processor 70. As other examples, user applications 77 may comprise firmware or, in some examples, may be implemented in discrete logic.

In operation, mobile device 15 receives input image data and processes the input image data in accordance with the techniques described herein. For example, image capture device 18 may capture an input image of an environment having a plurality of notes, such as workspace 20 of FIG. 1A having of notes 22. As another example, mobile device 15 may receive image data from external sources, such as cloud server 15, computer system 14 or mobile device 16, via receiver 74. In general, mobile device 15 stores the image data in data storage 68 for access and processing by note management application 78 and/or other user applications 77.

As shown in FIG. 1B, user applications 77 may invoke kernel functions of operating system 64 to output a graphical user interface (GUI) 79 for presenting information to a user of mobile device. As further described below, note management application 78 may construct and control GUI 79 to provide an improved electronic environment for generating and manipulating corresponding digital notes representative of physical notes 22. For example, note management application 78 may construct GUI 79 to include mechanisms that allows user 26 to easily control events that are automatically triggered in response to capturing notes of certain characteristics. In addition, note management application 78 may construct GUI 79 to include mechanisms that allow user 26 to manage relationships between groups of the digital notes.

FIG. 1C is a block diagram illustrating one example implementation of note management application 78 that operates in accordance with the techniques described herein. Although described as a user application 77 executing on mobile device 15, the examples described herein may be implemented on any computing device, such as cloud server 12, computer system 14, or other mobile devices.

In this example, note management application 78 includes image processing engine 82 that provides image processing and object recognition functionality. Image processing engine 82 may include image communication module 90, note identification module 86 and digital note generation module 88. In addition, image processing engine 82 includes image processing Application Programming Interfaces (APIs) 95 that provide a library of image manipulation functions, e.g., image thresholding, masking, filtering, edge detection, machine learning/artificial intelligence systems, and the like, for use by the other components of image processing engine 82.

In general, image data may be stored in data storage device 68. In this example, note management application 78 stores images 97 within data storage device 68. Each of images 97 may comprise pixel data for environments having a plurality of physical images, such as workspace 20 of FIG. 1A.

As described herein, note identification module 86 processes images 97 and identifies (i.e., recognizes) the plurality of physical notes in the images. Digital note generation module 88 generates digital notes 99 corresponding to the physical notes recognized within the images 97. For example, each of digital notes 99 corresponds to one of the physical notes identified in an input image 97. During this process, digital note generation module 88 may update database 94 to include a record of the digital note, and may store within the database information (e.g., content) extracted from the input image within boundaries determined for the physical note as detected by note identification module 86. Moreover, digital note generation module 88 may store within database 94 metadata associating the digital notes into one or more groups of digital notes. Note identification module 86 can also perform note tracking in order to track digital notes throughout the processes described herein, for example embodiments 1-4 described below. The tracking can include, for example, a location of the digital notes, a status of the digital notes, changes to the digital notes, creators of the digital notes or others who make updates to the digital notes.

Further, note management application 78 may be configured, e.g., by user input 26, to specify rules 101 that trigger actions in response to detection of physical notes having certain characteristics. For example, user interface 98 may, based on the user input, map action to specific characteristics of notes. Note management application 78 may output user interface 98 by which the user is able to specify rules having actions, such as a note grouping action, or an action related to another software application executing on the mobile device, such as an action related to a calendaring application. For each rule, user interface 98 allows the user to define criteria for triggering the actions. During this configuration process, user interface 98 may prompt the user to capture image data representative of an example note for triggering an action and process the image data to extract characteristics, such as color or content. User interface 98 may then present the determined criteria to the user to aid in defining corresponding rules for the example note.

Image communication module 90 controls communication of image data between mobile device 15 and external devices, such as cloud server 12, computer system 14, mobile device 16, or image capture device 18. In some examples, image communication module 90 may, for example, allow a user to communicate processed or unprocessed images 97 of environments and/or digital notes and associated information extracted therefrom including metadata from database 68. In some examples, image communication module 90 exports this data to a zip file that may be communicated by FTP, HTTP, email, Bluetooth or other mechanism.

In the example of FIG. 1C, note management application 78 includes user interface 98 that constructs and controls GUI 79 (FIG. 1B). As described below, user interface 98 may, in some examples, output for display an input image 97 overlaid with the plurality of digital notes 99, where each of the digital notes is overlaid in place of a corresponding physical note. In addition, user interface 98 may display a group of digital notes 99 that has been designated by the user. This group of digital notes 99 may be, for example, a subset of the digital notes recognized in a particular input image 97. User interface 98 may display this designated group (set) of the digital notes on a second portion of GUI 79 and allow user 26 to easily add or remove digital notes 99 from the designated group.

In some example implementations, user interface 98 provides an image editor 96 that allows a user to edit the overlay image and/or the digital notes. In another example, digital note generation module 88 may include a process or processes that enhances the extracted information from the input image.

FIG. 1D illustrates another example embodiment of a note recognition system 100A. The system 100A can include a processing unit 110, one or more notes 120, a sensor 130, and note content repository 140. The processing unit 110 can include one or more processors, microprocessors, computers, servers, and other computing devices. The sensor 130, for example, an image sensor, is configured to capture a visual representation of a scene having the one or more notes 120. The sensor 130 can include at least one of a camera, a video recorder, an infrared camera, a CCD (Charge Coupled Device) array, a scanner, or the like. The visual representation can include at least one of an image, a video, a sequence of images (i.e., multiple images taken within a time period and/or with an order), a collection of images, or the like. The processing unit 110 is coupled to the sensor 130 and configured to receive the visual representation. In some cases, the processing unit 110 is electronically coupled to the sensor 130. The processing unit 110 is configured to recognize at least one of the one or more notes 120 from the visual representation. In some embodiments, the processing unit 110 is configured to recognize note(s) by determining the general boundary of the note(s). After a note is recognized, the processing unit 110 extracts the content of the note. In some cases, the processing unit 110 is configured to recognize and extract the content of more than one note from a visual representation of a scene having those notes.

In some cases, the processing unit 110 can execute software or firmware stored in non-transitory computer-readable medium to implement various processes (e.g., recognize notes, extract notes, etc.) for the system 100A. The note content repository 140 may run on a single computer, a server, a storage device, a cloud server, or the like. In some other cases, the note content repository 140 may run on a series of networked computers, servers, or devices. In some implementations, the note content repository 140 includes tiers of data storage devices including local, regional, and central. The notes 120 can include physical notes arranged orderly or randomly in a collaboration space and the sensor 130 generates a visual representation of the notes 120 in the collaboration space.

In some implementations, the note recognition system 100A can include a presentation device (not shown in FIG. 1D) to show to the user which notes are recognized and/or which notes' content have been extracted. Further, the note recognition system 100A can present the extracted content via the presentation device. In some embodiments, the processing unit 110 can authenticate a note before extracting the content of the note. If the note is authenticated, the content will be extracted and stored in the note content repository 140.

FIG. 1E illustrates an embodiment of a note management system 100B. In this embodiment, the note management system 100B includes processing unit 110, one or more notes 120, one or more note sources 150, and a note content repository 140. In some cases, the system 100B includes a presentation device 160. The processing unit 110, the notes 120, and the note content repository 140 are similar to the components for the note recognition system 100A as illustrated in FIG. 1A. The note sources 150 can include sources to provide content of physical notes, such as a visual representation of a scene having one or more notes, and sources to provide content of digital notes, such as a data stream entered from a keyboard. In some embodiments, the note management system 100B includes a first source and a second source, and the first source is a visual representation of a scene having one or more notes 120. The first source and the second source are produced by different devices. The second source includes at least one of a text stream, an image, a video, a file, and a data entry. The processing unit 110 recognizes at least one of the notes from the first source and extracts the content of the note, as discussed in the note recognition system 100A. In some cases, the processing unit 110 labels the note with a category. The processing unit 110 can label a note based on its specific shape, color, content, and/or other information of the note. For example, each group of note can have a different color (e.g., red, green, yellow, etc.).

In some embodiments, the note management system 100B can include one or more presentation devices 160 to show the content of the notes 120 to the user. The presentation device 160 can include, but not limited to, an electronically addressable display, such as a liquid crystal display (LCD), a tablet computer, a projector, an electronic billboard, a cellular phone, a laptop, or the like. In some implementations, the processing unit 110 generates the content to display on the presentation device 160 for the notes in a variety of formats, for example, a list, grouped in rows and/or column, a flow diagram, or the like.

Various components of the note recognition system and note management system, such as processing unit, image sensor, and note content repository, can communicate via a communication interface. The communication interface includes, but not limited to, any wired or wireless short-range and long-range communication interfaces. The short-range communication interfaces may be, for example, local area network (LAN), interfaces conforming to a known communications standard, such as Bluetooth standard, IEEE 802 standards (e.g., IEEE 802.11), a ZigBee or similar specification, such as those based on the IEEE 802.15.4 standard, or other public or proprietary wireless protocol. The long-range communication interfaces may be, for example, wide area network (WAN), cellular network interfaces, satellite communication interfaces, etc. The communication interface may be either within a private computer network, such as intranet, or on a public computer network, such as the internet.

### Collaboration Using Video Capture for Notes

Embodiments 1-4 described below can use an instant communication feature by holding one or more physical notes to a camera on the participants devices, or detecting physical notes within view of the camera, for the software application to convert the physical notes to corresponding digital notes.

This instant communication feature is a method to instantly communicate by the way of a physical note, dry erase white board, or other physical product that is viewed through a camera, for example image capture device 18. The camera can be, for example, a web camera, or a computer, cell phone or similar digital device camera. This method allows for faster communication with a group or individual without the need, for example, to log into a system, or perform the activity of typing a note or content to send it digitally through an email system. This method eliminates the need to use a keyboard or cursor control device, allowing a participant to sketch on a whiteboard or physical note, for example, which can be viewed by others after detection via the camera and conversion to a corresponding digital note.

By utilizing the cameras already in use by participants working remotely or on their laptop computers, for example, this instant communication feature creates a way for participants to simply write on a physical note and then hold the note to the camera for capture by the software application and conversion to a corresponding digital note where the digital note can then be added to a digital tool, or sent to the facilitator, for continued collaboration. Participants can also collaborate by pointing a camera at a whiteboard and sketch or add content to the whiteboard to be viewed by the facilitator or other participants as such content is converted to corresponding digital notes that are sent to the facilitator and added to the group. The camera can also be a smart camera turned on and pointing to a dry erase wall in a meeting room. Just placing a physical note on the wall could trigger the camera to automatically capture the note and convert it to a corresponding digital note to share with remote participants.

In one version of this instant communication method, a participant or other user writes on a physical note, holds the physical note up to camera that is already on, and a digital version of note appears in a digital collaboration tool such as the collaboration feature described herein. The physical note can be converted into the corresponding digital note by the software application automatically detecting the presence of a physical note in the camera view and converting the physical note to a corresponding digital note. This conversion can occur as described above in the Note Management System section.

The note can be automatically detected by using machine learning techniques to process video frames in the video feed from the camera (e.g., image capture device 18) in order to recognize an object in the video frames that qualifies as a note. The video frames can be obtained and processed from the video feed on the server side conducting the video conferencing. The video frames can alternatively be obtained and processed on the client side by using a software application as a virtual camera linked to the camera in order to route the video feed through the software application.

Alternatively, a participant or user can scan written text and move the scanned text into a “chat” window in a video conferencing meeting. The written text can include fiduciary marks on the writing surface (e.g., physical note, dry erase board) to require proprietary notes, for example an App Clip Code (or other machine-readable optical label), a logo, or any printed graphic design. Another option is for the participant or user to draw a square around a note in a notebook or another writing surface to indicate content to be captured as a note. Also, multiple physical notes can be captured at the same time. Other content that can be captured along with conversion of the physical note to a corresponding digital note includes rich content such as a voice explanation of the physical note a participant is holding in the camera view, and metadata such as an author of the note and possibly a date and time stamp. Additionally, orientation angle (e.g., diamond versus square), placement on the board, and placement relative to other notes could also be of interest. If the note is created or placed in a group, group metadata including group size, time of creation, and number of notes could be associated with the created note. If the note moved, more metadata could also include note route, driver, distance travelled, and a relative natural language processing (NLP) sentiment analysis of new versus previous neighboring notes. Metadata can also include other aspects or characteristics of notes. The captured physical notes can also be used to indicate subsequent action or to organize notes in various categories (e.g., new action item, new idea, or delegate to another).

The term “instant” is only used as a label for this instant communication feature; the conversion of physical notes in camera view to corresponding digital notes typically occurs in real time but need not be instantaneous.

1. Merging Physical and Digital Notes into a Single Work Canvas.

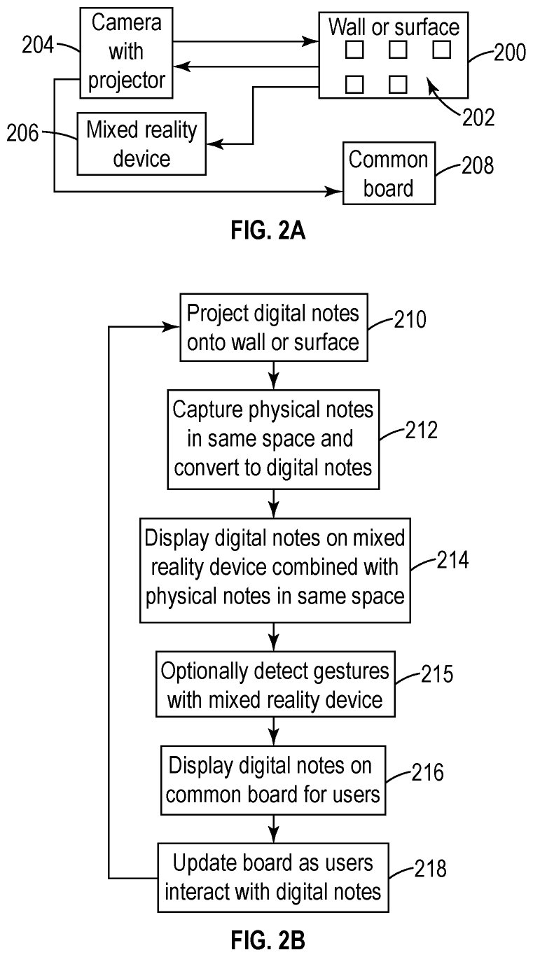

FIG. 2A is a diagram of a system for merging physical and digital notes into a single work canvas. The system includes a digital camera (e.g., digital image capture device) with a projector 204 for use in projecting digital notes 202 onto a wall or other surface 200. A mixed reality device 206 is used to view an enhanced version of projected digital notes 202, and the digital notes are also provided on a shared synchronous electronic board 208.

FIG. 2B is a flow chart of a method for merging physical and digital notes into a single work canvas using the system of FIG. 2A. This method can be implemented in software or firmware modules for execution by a processor. In the method, the projector within camera and projector 204 projects digital notes 202 onto wall or other surface 200 (step 210). The digital camera within camera and projector 204 captures physical notes in the same space on wall or surface 200 and converts the physical notes to corresponding digital notes (step 212). The notes can be converted as described, for example, in the above Note Management System section. The digital notes are displayed in mixed reality device 206 combined with the physical notes in the same space when viewing the wall or surface 200 through mixed reality device 206 (step 214).

Hand gestures can optionally be tracked (with the mixed reality device camera or other sensors) and interpreted as commands relating to the digital content, allowing users to interact with the digital content (step 215). The digital notes are also displayed on common board 208 for users in a session (step 216). Common board 208 is updated as the users interact with the digital notes on common board 208 (step 218). Common board 208 can be implemented, for example, via a shared electronic screen or user interface in video conferencing technology. Common board 208 can also exist in a virtual space, for example using the Mesh App from Microsoft Corporation.

Mixed reality device 206 is optional in that the work canvas (common board 208) can be produced using a projector without mixed reality device 206. However, the use of a mixed reality device can enhance the experience in this embodiment. A mixed reality device can include an augmented reality (AR) device, a virtual reality (VR) device, or both AR and VR devices. Examples of AR or VR devices include AR or VR goggles or smart glasses.

Through video capture and display technologies, this embodiment combines physical and digital repositionable notes into a single interface for sharing and manipulation by users in different locations. Physical notes in one location will appear as digital versions in other locations, and be viewed adjacent to other physical notes in each location by the users of the video conferencing. Real-time video capture in each location will allow the combined collection of notes to stay updated with changes from each user. The combined collection of notes can be viewed via a range of display technologies: A room mounted projector casts or projects an image of the digital notes to a wall, mixing them with physical notes on that wall. A mixed reality device displays the digital notes to the user and combines them with physical notes in their space, and an image of the physical notes is displayed on a computer or mobile device screen, combined with a representation of the digital notes from other locations. Alternatively, the notes can contain a fiducial, an identifier, or other information that synchronizes user devices to the same digital channel. The identifier can be implemented as, for example, the unique color, position, and location of notes.

As distributed teams become the standard or more common mode of work, there is a need for technologies that help a team have a sense they are working on the same material. This note capture technologies combined with advances in processing and display technologies can deliver an integrated solution to this need. This can apply to both synchronous and asynchronous work, meaning a team working collaboratively from different locations can concurrently contribute both physical and digital notes to the work product and have the total contribution be viewed as a single product from each location. Users in one location can build a collection of physical notes in the one location and continue that work in another location adding new physical notes to their previous collection, which now appears as a digital representation in the new location.

2. Note Recognition with Physical Obstructions.

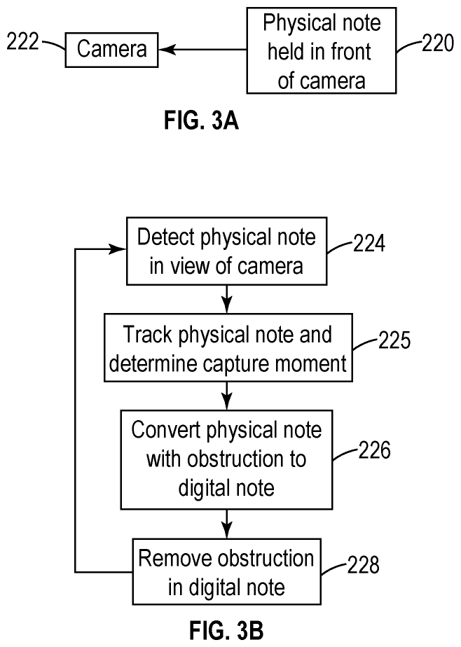

FIG. 3A is a diagram of a system for note recognition with physical obstructions. This system includes a digital camera 222 (e.g., digital image capture device) with a physical note 220 held in front of (in view of) camera 222.

FIG. 3B is a flow chart of a method for note recognition with physical obstructions. This method can be implemented in software or firmware modules for execution by a processor. In the method, physical note 220 is detected in view of camera 222 (step 224), which can occur as described above. The process can optionally track the corresponding physical note and determine the capture moment when the physical note was detected in view of the camera (step 225). Tracking the note can include, for example, identifying a position of the physical note when in view of the camera. The capture moment can include, for example, a date and time when the physical note was detected for conversion to a corresponding digital note. With a user holding up physical note 220, part of the note can be obstructed by, for example, the user's finger. The physical note with the obstruction 220 is converted to the corresponding digital note (step 226), and the obstruction in the digital note is removed (step 228). This process can automatically detect physical notes in front of a camera, as described above, and some of those physical notes can have an obstruction such as a user's finger. The process thus need not only detect physical notes with an obstruction.

Holding a physical note in front of a camera is a method of capture that allows rapid capture of multiple notes in succession. This feature may require the user to hold each note, thereby blocking a portion of the note surface from the camera view. This system recognizes the obstruction as a human finger (or other obstruction) and “fills-in” the missing note area, allowing the capture to simulate a full note. In particular, through machine learning, computer vision, or other artificial intelligence, as described above, the capture engine is trained to recognize a human finger (or other obstruction) partially blocking the full note shape, and substitute the blocked area with the completed note image. Other obstructions can include, for example, a clip or other mechanical device holding the note.

### 3. Reducing Data Consumption by Capturing Only Altered Content of Notes.

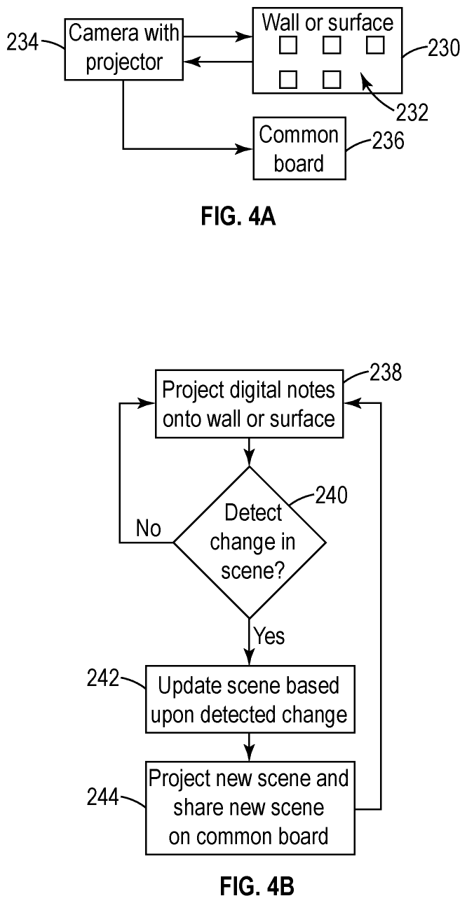

FIG. 4A is a diagram of a system reducing data consumption by capturing only altered content of notes. The system includes a digital camera (e.g., digital image capture device) with a projector 234 for use in projecting digital notes 232 onto a wall or other surface 230. The digital notes are also provided on a shared electronic board 236.

FIG. 4B is a flow chart of a method for reducing data consumption by capturing only altered content of notes. This method can be implemented in software or firmware modules for execution by a processor. In the method, the projector within camera and projector 234 projects digital notes 232 onto wall or other surface 230 (step 238). If a change is detected in the scene on wall or surface 230 via the camera in camera with projector 234 (step 240), the scene is updated based upon the detected change (step 242). The projector within camera with projector 234 projects the new (updated) scene onto wall or surface 230 and shares the new scene on common board 236 (step 244). Common board 236 can be implemented, for example, via a shared electronic screen or user interface in video conferencing technology. A change in the scene can include, for example, detecting a new digital note in the scene, a removal of one of the digital notes from the scene, a change in the content of the digital notes in the scene, or a position of the digital notes in the scene.

Through machine learning, computer vision, or other artificial intelligence, a real-time video capture engine is trained to recognize only physical repositionable notes in a physical environment and update only when the content, position or quantity of the notes changes. All other changes in the environment are disregarded, which can significantly reduce the data required to keep the note content updated with the most recent work content. This embodiment can also be implemented in part using, for example, human-occlusion code APIs to enhance or facilitate detection of changes in the environment.

As distributed teams become the standard or more common mode of work, capturing work product in a form that is easy to transmit can become a more critical need. Real-time video capture of notes in a physical space enables an entire work product to be maintained in digital form. Capturing an entire environment is data intensive, putting a drain on processing, storage, and energy usage. Training the system to monitor only the notes can improve overall efficiency and usability of the system.

4. Synchronizing Capture of Notes with Real-Time Audio and Visual Presentation.

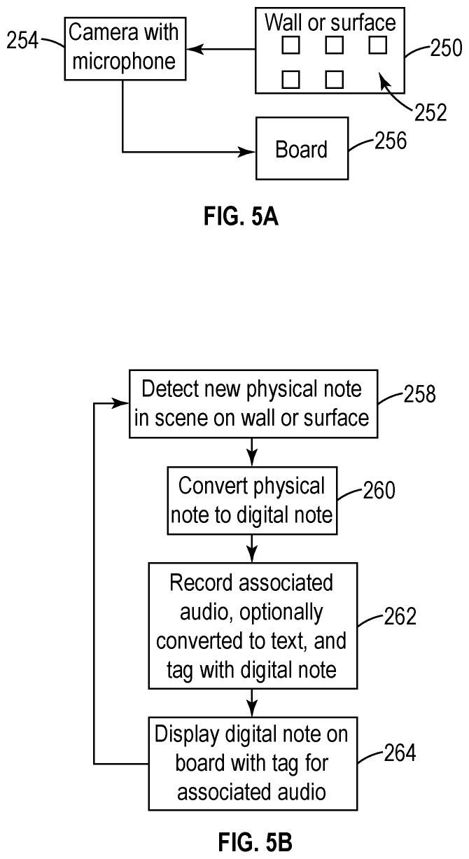

FIG. 5A is a diagram of a system for synchronizing capture of notes with real-time audio and visual presentation. The system includes a digital camera (e.g., digital image capture device) with a microphone 254 for use in projecting digital notes 252 onto a wall or other surface 250. The digital notes are also provided on an electronic board 256.

FIG. 5B is a flow chart of a method for synchronizing capture of notes with real-time audio and visual presentation. This method can be implemented in software or firmware modules for execution by a processor. In the method, the camera within camera with microphone 254 detects a new physical note in the scene on wall or surface 250 (step 258). The physical note is converted to the corresponding digital note (step 260). This conversion can occur as described above in the Note Management System section. The audio associated with the physical is recorded, optionally converted to text, and is tagged with the corresponding digital note (step 262). The recorded audio can be electronically associated with or stored with the corresponding digital note. The digital note is displayed on board 256 with the tag for the associated audio (step 264). The tag can include, for example, an icon for the user to select in order to access the recorded audio or optional corresponding text. Board 256 can be implemented with, for example, a screen or user interface accessible by the user.

As distributed teams become the standard or more common mode of work, capturing the full experience in a meeting becomes a more critical need. Synchronizing notes to the real-time audio can inform context that led to the creation of each note. Additionally, many work sessions include visual presentation materials that can also be synchronized to the notes and audios. This feature can allow users in remote locations and time-zones to efficiently experience the “real” context behind each physical note. Video capture of an environment including physical repositionable notes is thus enhanced to include simultaneous capture of the audio in the room and synchronous visual presentation materials selected by the user.

This embodiment can optionally use speaker recognition to associate voice data from only the author to the note. This embodiment can also optionally use artificial intelligence (AI) techniques to search the transcription of the meeting for a certain time period, for example 1-2 minutes, before and after the note and find conversations that appear related. Then that voice and image data can be saved with the corresponding note. The user could also be prompted to review associated metadata for relevance, improving the AI processing based on their feedback and saving storage space by deleting mistakenly-tagged video files.

1. A method for displaying physical and digital notes, comprising operations executed by a processor:
projecting digital notes onto a wall or surface for users;
capturing physical notes on the wall or surface, via an image capture device, and converting the physical notes to corresponding digital notes;
displaying on a mixed reality device the digital notes combined with the physical notes when the wall or surface is viewed through the mixed reality device; and
displaying the digital notes on a common electronic board for the users.

2. The method of claim 1, wherein the displaying on a mixed reality device operation comprises displaying on an augmented reality device the digital notes combined with the physical notes.

3. The method of claim 1, wherein the displaying on a mixed reality device operation comprises displaying on a virtual reality device the digital notes combined with the physical notes.

4. The method of claim 1, further comprising detecting, via the mixed reality device, gestures from a user of the mixed reality device.

5. The method of claim 4, further comprising interpreting the detected gestures as commands.

6. The method of claim 1, further comprising updating the common electronic board as users interact with the displayed digital notes.

7. A method for generating a digital note, comprising operations executed by a processor:
automatically detecting a physical note via an image capture device;
converting the detected physical note to a corresponding digital note; and
if the physical note has an obstruction, removing the obstruction in the digital note.

8. The method of claim 7, further comprising filling in an area of the note corresponding with the obstruction to simulate a full note for the digital note.

9. The method of claim 7, further comprising tracking the detected physical note.

10. The method of claim 7, further comprising determining a moment when the physical note was detected.

11. A method for displaying digital notes, comprising operations executed by a processor:
projecting digital notes onto a wall or surface for users;
detecting a change in a scene, via an image capture device, on the wall or surface;
updating the scene based upon the detected change;
projecting a new scene on the wall or surface based upon the updating; and
sharing the new scene on a common electronic board for the users.

12. The method of claim 11, wherein the detecting operation comprises detecting a change in content of the digital notes in the scene.

13. The method of claim 11, wherein the detecting operation comprises detecting a change in position of the digital notes in the scene.

14. The method of claim 11, wherein the detecting operation comprises detecting a change in quantity of the digital notes in the scene.

15.-19. (canceled)
